(19) United States
(12) Patent Application Publication
(10) Pub. No.: US 2021/0295350 A1
(43) Pub. Date: Sep. 23, 2021

(54) COUNTERFEIT DETECTION BASED ON TRACKING MANUFACTURING AND/OR WEARING ARTIFACTS

(71) Applicant: NEC Corporation Of America, Herzlia (IL)

(72) Inventors: Tsvi LEV, Tel-Aviv (IL); Kota Iwamoto, Herzliya (IL)

(73) Assignee: NEC Corporation Of America, Herzlia (IL)

(21) Appl. No.: 16/876,188

(22) Filed: May 18, 2020

Related U.S. Application Data
(63) Continuation-in-part of application No. 16/822,125, filed on Mar. 18, 2020.

(51) Int. Cl. G06Q 30/00; G06Q 50/26; G06K 19/07; G06N 20/00; G06K 9/62; G06K 9/00

(52) U.S. Cl. CPC G06Q 30/0185; G06Q 50/265; G06K 9/00885; G06N 20/00; G06K 9/6202; G06K 19/0723

(57) ABSTRACT

Provided herein are methods and systems for detecting counterfeit of a personal object, comprising, analyzing one or more images depicting a personal object to identify one or more wearing marks in the personal object induced by one or more wearing conditions, generating a wearing pattern comprising the one or more wearing marks, comparing between the wearing pattern and one or more previous wearing patterns created for the personal object based on past images of the personal object, and determining whether the personal object is genuine or counterfeit based on the comparison.

### RELATED APPLICATION(S)

This application is a Continuation-in-Part (CIP) of U.S. patent application Ser. No. 16/822,125 filed on Mar. 18, 2020, the contents of which are all incorporated by reference as if fully set forth herein in their entirety.

### FIELD AND BACKGROUND OF THE INVENTION

The present invention, in some embodiments thereof, relates to detecting counterfeit personal objects, and, more specifically, but not exclusively, to detecting counterfeit personal objects based on analysis of the personal objects to identify and track manufacturing and/or wearing artifacts.

Identity theft and/or impersonation through the use of counterfeit personal objects exclusively associated with respective persons (users) has long become a major concern which is significantly emphasized with the increasing use of automated objects.

For example, counterfeit identification (ID) objects such as ID card, ID paper, ID tag and/or the like may be used to impersonate as another person in attempt to access one or more restricted areas, limited access systems and/or the like for one or more potentially malicious purposes. In another example, one or more counterfeit articles of personal objects allocated for exclusive use by respective users, for example, credit cards, smart cards, personal gift cards and/or the like may be used to access financial resources of the respective users, for example, banking accounts, online resources and/or the like.

Counterfeiting may be even applied by malicious parties to overcome biometric authentication by using one or more counterfeit objects and/or articles, for example, an images, a model, a tape, a cast and/or the like in attempt to replicate one or more organic features of users which are checked for the biometric authentication, for example, face, eye, iris, ear, skin, fingerprint and/or the like.

### SUMMARY OF THE INVENTION

According to a first aspect of the present invention there is provided a method of detecting counterfeit of a personal object, comprising:
Analyzing one or more images depicting a personal object to identify one or more wearing marks in the personal object induced by one or more wearing conditions.
Generating a wearing pattern comprising the one or more wearing marks.
Comparing between the wearing pattern and one or more previous wearing patterns created for the personal object based on past images of the personal object.
Determining whether the personal object is genuine or counterfeit based on the comparison.

According to a second aspect of the present invention there is provided a system for detecting counterfeit of a personal object, comprising using one or more processors executing a code, the code comprising:
Code instruction to analyze one or more images depicting a personal object to identify one or more wearing marks in the personal object induced by one or more wearing conditions.
Code instruction to generate a wearing pattern comprising the one or more wearing marks.
Code instruction to compare between the wearing pattern and one or more previous wearing patterns created for the personal object based on past images of the personal object.
Code instruction to determine whether the personal object is genuine or counterfeit based on the comparison.

According to a third aspect of the present invention there is provided a method of detecting counterfeit of a personal object, comprising:
A signature generation process comprising:
   Analyzing one or more images of a personal object to identify one or more manufacturing defects each comprising one or more deviations from object generation instructions used in a manufacturing process to produce the personal object.
   Generating a signature recording the one or more manufacturing defects.
A verification process comprising:
   Obtaining the signature.
   Analyzing one or more images of the personal object to identify the one or more manufacturing defects recorded in the signature.
   Determining whether the personal object is genuine or counterfeit based on presence or absence of the one or more manufacturing defects.

According to a fourth aspect of the present invention there is provided a system for detecting counterfeit of a personal object, comprising:
In a sealing process using one or more processors executing a code, the code comprising:
   Code instruction to analyze one or more images of a personal object to identify one or more manufacturing defects each comprising one or more deviations from object generation instructions used in a manufacturing process to produce the personal object.
   Code instruction to generate a signature recording the one or more manufacturing defects.
In a verification process using one or more processors executing a code, the code comprising:
   Code instruction to obtain the signature.
   Code instruction to analyze one or more images of the personal object to identify the one or more manufacturing defects recorded in the signature.
   Code instruction to determine whether the personal object is genuine or counterfeit based on presence or absence of the one or more manufacturing defects.

In a further implementation form of the first, second, third and/or fourth aspects, the personal object is associated with a respective user and is used for verification of an identity of the respective user.

In a further implementation form of the first, second, third and/or fourth aspects, the personal object associated with a respective user and is intended for exclusive use by the associated user.

In a further implementation form of the first, second, third and/or fourth aspects, the personal object is a member of a group consisting of: an identification (ID) card, a credit card, an ID tag, an RFID tag and, an ID paper.

In an optional implementation form of the first, second, third and/or fourth aspects, the personal object further comprising one or more organic features of a respective user which is used for biometric verification of an identity of the respective user, each of the one or more organic features is a member of a group consisting of: a face, an iris, a fingerprint, and a skin.

In a further implementation form of the first and/or second aspects, the one or more wearing conditions comprising: time, an environmental condition, a mechanical interaction and a chemical interaction.

In an optional implementation form of the first and/or second aspects, one or more of the wearing marks are beyond a production ability of production means used to produce the personal object and is hence non-reproducible.

In an optional implementation form of the first and/or second aspects, the personal object is determined to be genuine or counterfeit based on a comparison between the wearing pattern and a wearing mask estimated for the personal object based on analysis of one or more of the previous wearing patterns.

In a further implementation form of the first and/or second aspects, the wearing mask is estimated according to one or more wearing effects reflected by a gradual wearing state identified based on comparison between a plurality of previous wearing patterns.

In a further implementation form of the first and/or second aspects, the wearing mask is estimated based on a time period since issuance of the personal object.

In a further implementation form of the first and/or second aspects, the wearing mask is estimated based on an outcome of one or more trained Machine Learning (ML) models applied to one or more of the images. T one or more trained ML models are trained with a plurality of training wearing patterns derived from a plurality of training images of a plurality of personal objects such as the personal object.

In a further implementation form of the first and/or second aspects, at least some of the plurality of training wearing patterns reflect a gradual wearing state of at least some of the plurality of personal objects as identified in respective images of the plurality of images.

In a further implementation form of the third and/or fourth aspects, one or more of the deviations are beyond a production ability of production means used to produce the personal object and is hence non-reproducible.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of detecting counterfeit of a personal object based on wearing marks identified in the personal object, according to some embodiments of the present invention;

FIG. 2 is a schematic illustration of an exemplary system for detecting counterfeit of a personal object based on wearing marks identified in the personal object, according to some embodiments of the present invention;

FIG. 3A and FIG. 3B present images of exemplary personal objects suffering wearing marks which may be analyzed to detect counterfeit objects, according to some embodiments of the present invention;

FIG. 4 presents images of exemplary organic features suffering wearing marks be analyzed to detect counterfeit, according to some embodiments of the present invention;

FIG. 5 is a flowchart of an exemplary process of detecting counterfeit of a personal object based on manufacturing defects identified in the personal object, according to some embodiments of the present invention;

FIG. 6 is a schematic illustration of an exemplary system for detecting counterfeit of a personal object based on manufacturing defects identified in the personal object, according to some embodiments of the present invention; and

FIG. 7 is an image of an exemplary personal object suffering manufacturing defects be analyzed to determine whether the personal object is genuine or counterfeit, according to some embodiments of the present invention.

### DESCRIPTION OF SPECIFIC EMBODIMENTS OF THE INVENTION

The present invention, in some embodiments thereof, relates to detecting counterfeit personal objects, and, more specifically, but not exclusively, to detecting counterfeit personal objects based on analysis of the personal objects to identify and track manufacturing and/or wearing artifacts.

According to some embodiments of the present invention, there are provided methods, systems and computer program products for detecting a counterfeit personal objects based on identifying and tracking wearing artifacts, specifically wearing marks detected in the personal object. As such, the personal object may be validated, verified and/or authenticated to be genuine or counterfeit not according to a standard common reference reflecting the personal object but rather based on the wearing state of the personal object which may be characterized by unique wearing marks in the personal object thus distinguishing the personal object from potential counterfeit articles and/or objects.

The personal object which is associated with a certain user may include one or more objects which may be used for identification, of the respective user, i.e., for verifying an identity of the respective user, for example, an identification (ID) card, an ID tag, a Radio Frequency ID (RFID) tag and, an ID paper (e.g., passport, driver license, etc.) and/or the like. The personal object may further include one or more objects which may be allocated and/or intended for exclusive use by the respective user, for example, a credit card, a debit card, a smart card, a personal gift card and/or the like. The personal object may further include one or more organic features of the respective user which may be used for biometric verification of an identity of the respective user, for example, a face, an ear, an eye, an iris, a fingerprint, a skin and/or the like.

The personal object may be analyzed to identify its wearing state and create a wearing pattern accordingly to include one or more wearing marks detected in the personal object. Specifically, one or more of images of the personal object may be analyzed to identify the wearing mark(s), in particular one or more visual wearing marks, for example, de-coloration (fading, dullness, etc.), scratches, wrinkles (creases, furrows, etc.), tearing, physical deterioration and/or the like induced by one or more wearing conditions, for example, time, an environmental condition (e.g. exposure to light, humidity, etc.), a mechanical interaction with one or more other objects and/or forces, a chemical interaction with one or more contacting, radiating and/or emitting materials or substances and/or the like. In case of the personal object comprising one or more of the organic features, the wearing marks may include, for example, for example, wrinkles, scars, vitiligo, freckles, liver spots, de-coloration areas and/or the like induced in the organic feature by one or more wearing conditions, for example, age (time), environmental condition (e.g. exposure to light, cold, heat, humidity, etc.), fatigue, injury, illness, intentional alterations (e.g. tattoo, piercing, etc.), and/or the like.

Moreover, one or more of the wearing marks may be analyzed with respect to a manufacturing means available for producing the personal object and/or counterfeit objects/articles used to replicate the organic feature(s) in order to detect and select one or more wearing marks which are beyond a resolution, a capacity and/or an ability of the manufacturing means and are therefore non-reproducible.

The personal object may be examined to check to evaluate and/or determine whether the personal object is genuine or counterfeit by comparing between the wearing pattern created for the personal object and one or more previous wearing patterns created for the personal object based on analysis(s) of one or more past images of the personal object. For example, since each personal object essentially wears over time, identifying one or more wearing marks which are missing in the current wearing pattern of the specific personal object article compared to the previous wearing pattern(s) of the same personal object article may be highly indicative that the personal object is not the same personal object recorded in the previous wearing pattern(s) and is thus a potential counterfeit object.

Moreover, as the wearing mark(s) recorded in the wearing pattern may be inflicted by the natural and typically hectic and non-repeatable wearing conditions, selected wearing mark(s) which are non-reproducible may be thus extremely difficult and potentially impossible to replicate by artificial means. As such, each personal object article may be impossible to be replicated, duplicated, imitated and/or otherwise simulated by counterfeit objects and/or articles having the exact same wearing mark(s) recorded in the previous wearing pattern(s).

During the passage of time since the time of capturing the images used to create the previous wearing pattern(s) the personal object may include, develop and./or suffer one or more additional wearing marks which are naturally not recorded in the previous wearing pattern(s). To overcome this limitation, the wearing pattern generated for the personal object may be compared to an estimated wearing mask computed for the personal object based on one or more of the previous wearing patterns, in particular a most recent previous wearing pattern. The estimated wearing mask may include one or more wearing marks which are not recorded in the previous wearing pattern(s) but may be possible and/or probable wearing marks legitimately and/or genuinely resulting from one or more of the wearing conditions. Optionally, the estimated wearing mask may be further computed and/or adjusted based on one or more wearing effects identified to affect the specific personal object. The wearing effect(s) specifically applicable to the specific personal object may be detected by analyzing a gradual degradation in the wearing state of the personal object as reflected by the plurality of previous wearing patterns.

Optionally, one or more trained Machine Learning (ML) models, for example, a neural network, a Support Vector Machine (SVM) and/or the like may be applied to compute and/or generate the wearing mask and compare between the wearing pattern and the wearing mask to identify differences in the wearing mark(s) recorded in them. The ML model(s) may be trained to create a general wearing mask comprising wearing mark(s) which are induced by the wearing conditions in personal objects which are used, carried and/or stored in standard, average and/or typical manner common to a plurality of users. Optionally, one or more of the ML models may be further trained to generate a specific wearing mask for a certain personal object which may reflect specific and possibly unique wearing mark(s) which are induced by the specific wearing conditions to which the specific personal object is exposed.

According to some embodiments of the present invention, there are provided methods, systems and computer program products for detecting counterfeit personal objects based on identifying and tracking manufacturing artifacts, specifically manufacturing defects detected in the personal object. As such, the personal object may be validated, verified and/or authenticated to be genuine or counterfeit according to unique manufacturing defects deviating from manufacturing instructions used to produce the personal object thus distinguishing each article of the personal product from other similar articles of the personal object produced according to the same manufacturing instructions.

During a manufacturing process of the personal object, specifically after the manufacturing process is complete, the personal object may be analyzed to identify one or more manufacturing defects present in the personal object which comprise one or more deviations from the manufacturing instructions. Specifically, one or more of images of the personal object may be analyzed to identify the manufacturing defect(s), in particular one or more visual manufacturing defect(s) which include deviations for the manufacturing instructions which may typically may result from one or more inconsistencies or deviations during the manufacturing process of the personal object, for example, one or more imprecisions of an equipment and/or machinery used to produce the personal object, one or more inherent random characteristics of one or more processes applied to produce the personal object, one or more inherent random parameters, attributes and/or characteristics of one or more materials and/or substances used to produce the personal object and/or the like.

Moreover, one or more of the detected manufacturing defects may be further analyzed with respect to the manufacturing means available for producing the personal object and/or counterfeit objects/articles used to replicate the organic feature(s) in order to detect and select one or more manufacturing defects which are beyond a resolution, a capacity and/or an ability of the manufacturing means and are therefore non-reproducible. Since each of the manufacturing defects includes deviation(s) from the manufacturing instructions which may be unique for the specific personal object article, the signature of the personal object may be also unique for each personal object article.

A signature may be created accordingly for the specific article of the personal object to include one or more of the manufacturing defects detected in the personal object. Moreover, one or more of the manufacturing defects selected to the signature may include non-reproducible manufacturing defects comprising non-reproducible deviations for the manufacturing instructions. Since each of the manufacturing defects may include deviation(s) from the manufacturing instructions which are unique for the specific personal object article, and optionally non-reproducible, the signature created for the personal object may be also unique for each personal object article.

After associated with a respective user, the personal object (article) may be examined to check to evaluate and/or determine whether the personal object is genuine or counterfeit for example, to identify the associated user according to the personal object (e.g. ID card, RFID tag, ID paper, etc.) and/or to authorize the associated user to use the personal object (e.g. credit card, smart card, etc.).

One or more images of the personal object may be analyzed compared to signature to detect the manufacturing defect(s) recorded in the signature created for the personal object at end of its manufacturing process. The personal object may be then determined to be genuine or counterfeit based on a match between the personal object as reflected by the image(s) and the signature, i.e., according to presence and/or absence of the manufacturing defect(s) recorded in the signature. Since the signature of each personal object article may be unique, incompliance (no-match) between the manufacturing deviation pattern and the signature may be highly indicative that the personal object is not the same personal object recorded in the signature and is thus a potential counterfeit object.

Detecting counterfeit personal objects based on comparison of their distinguishing and optionally non-reproducible wearing marks and/or manufacturing defects may present major advantages compared to existing methods for counterfeit detection.

First, in order to detect counterfeit personal objects, some of the existing methods may utilize complex personal objects comprising unique features which are hard and potentially impossible to replicate, for example, credit cards embedded with hologram images, ID papers and/or cards embedded with water marks and/or the like. Such complex personal objects and advanced unique features may require special materials, special production means, special technologies and/or the like which may significantly increase the utilized computation resources (processing resources, storage resources, etc.), time and/or cost for producing the personal objects. In contrast, taking advantage of the wearing mark(s) identified in personal objects which may make each such personal object unique and distinguishable compared to potential counterfeit objects and/or articles may allow usage of simple and significantly cheaper personal objects which may require significantly reduced computation resources, time and/or cost for their production.

Moreover, at least some of the wearing marks which the personal objects may sufferer and exhibit may be very difficult to duplicate using artificial means and therefore reproducing such wearing marks to replicate, imitate, duplicate and/or otherwise simulate a genuine personal object may be significantly difficult and practically unfeasible. This may further facilitate the option of using simple and cheap personal objects which may further reduce the computation resources, time and/or cost for producing the personal objects.

Furthermore, creating the estimated wearing mask may allow reliable determination of whether the personal object is genuine or counterfeit may significantly reduce the false positive detection in which a genuine personal object may be determined to be counterfeit based on a degradation identified in the wearing state of the personal object while in fact the wearing mark(s) reflecting the degraded wearing state may be genuinely and legitimately induced by the wearing conditions.

In addition, adjusting the estimated wearing mask according to the gradual wearing identified for specific personal objects may allow accurately adjusting and adapting the estimated wearing mask according to the wearing effects applicable for the respective personal object thus further improving accuracy of the acceptable wearing state which may further improve the determination accuracy of whether the personal object is genuine or counterfeit while reducing false positive detection.

Also, applying the ML model(s) to compute the wearing mask and compare it to the current wearing state (pattern) of the personal objects may further increase counterfeit detection performance (e.g., accuracy, reliability, consistency, etc.) while significantly reducing the computing resources and/or time required to adjust to new wearing marks, new personal objects and/or the like compared to a rule based counterfeit detection.

Additionally, in order to detect counterfeit personal objects some of the existing methods may utilize complex personal objects designed, configured and produced to include unique features which may distinguish each individual personal object article thus making it difficult and possibly impossible to create counterfeit objects. Such complex personal objects may significantly increase computation resources utilization, time and/or cost for producing the special personal objects. In contrast, taking advantage of the production defect(s) optionally non-reproducible production defect(s) identified in personal object which makes each personal object article seal unique and distinguishable compared to other similar personal objects, may allow usage of significantly more simple and cheap personal objects which may significantly reduce the computation resources, time and/or cost.

Moreover, as one or more of the manufacturing defect(s) recorded in the manufacturing deviation pattern may be non-repeatable, replicating, duplicating, simulating and/or otherwise reproducing such manufacturing defect(s) by artificial means may be extremely difficult and potentially impossible. As such, the personal object may be impossible to be reproduced by counterfeit objects and/or articles having the exact same manufacturing defect(s) recorded in the signature.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

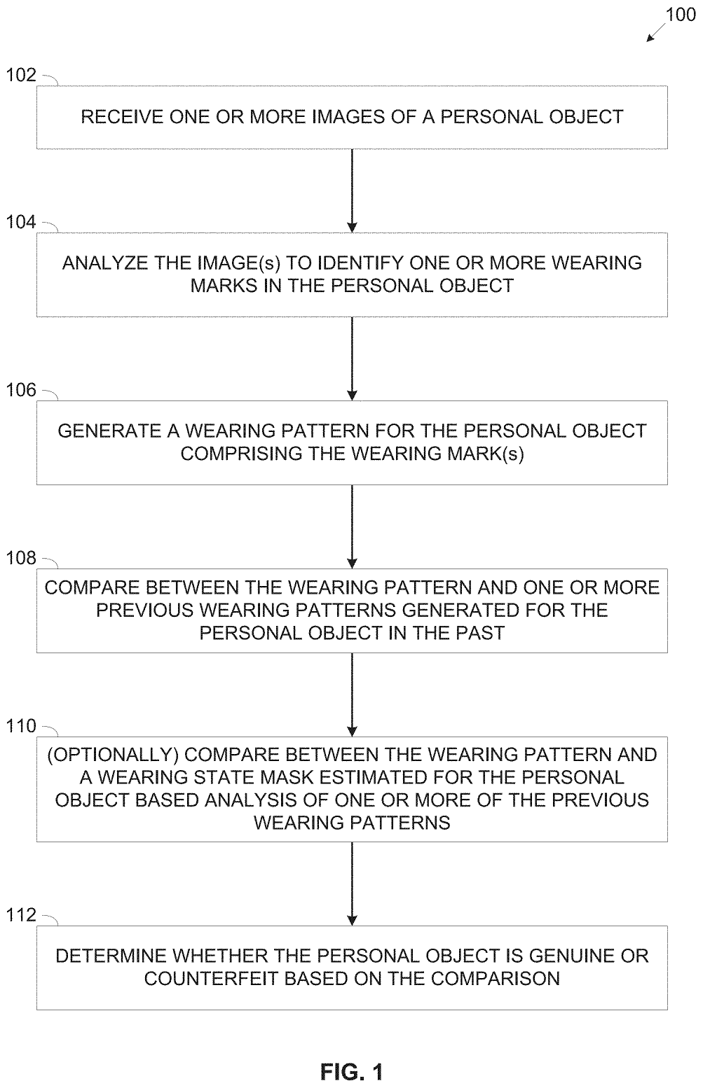

Referring now to the drawings, FIG. 1 illustrates a flowchart of an exemplary process of detecting counterfeit of a personal object based on wearing marks identified in the personal object, according to some embodiments of the present invention.

An exemplary process 100 may be executed to detect counterfeit of a personal object used for identification of a respective associated user and/or intended for exclusive use by the respective user based on detecting and optionally tracking changes in a wearing state the personal object. The process 100 may comprise identifying and tracking wearing marks detectable in the personal object such that the personal object may be validated, verified and/or authenticated to be genuine or counterfeit according to presence or absence of unique wearing mark(s) distinguishing each personal product article from other similar personal products articles.

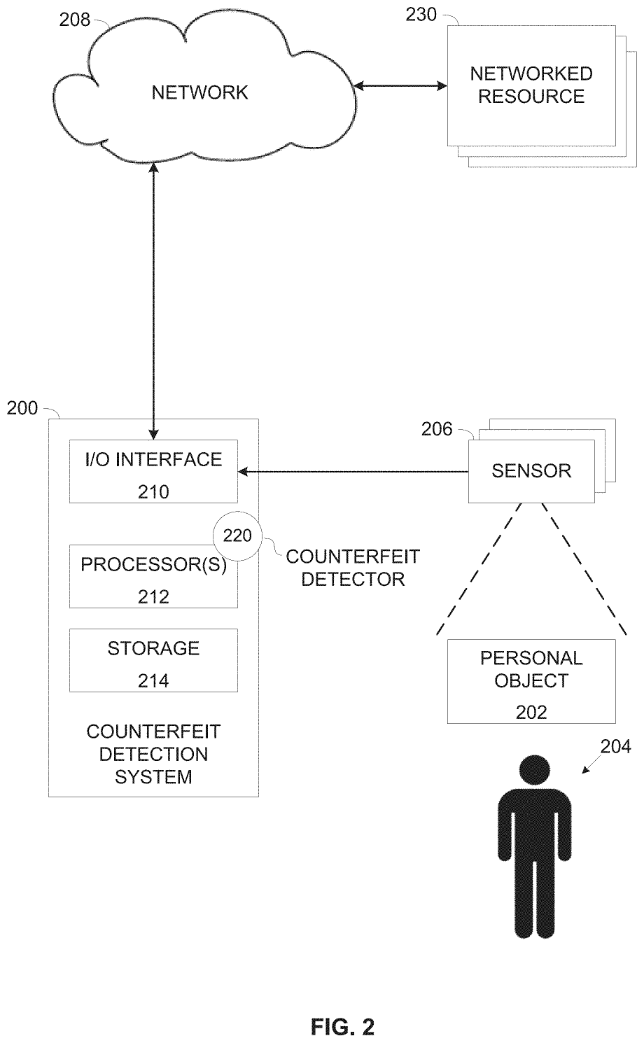

Reference is also made to FIG. 2, which is a schematic illustration of an exemplary system for detecting counterfeit of a personal object based on wearing marks identified in the personal object, according to some embodiments of the present invention.

A counterfeit detection system 200, for example, a computer, a mobile device (e.g. cellular device, tablet, laptop, etc.), a server, a computing node, a cluster of computing nodes and/or the like may execute a process such as the process 100 to analyze each a wearing state of a personal object 202 associated with a respective user 204 to detect potential counterfeit of the personal object 202.

The personal object 202 may include one or more objects which may be used for identification, of the respective user 204, i.e., for verifying an identity of the respective user 204, for example, an ID card, an ID tag, an RFID tag and, an ID paper (e.g., passport, driver license, etc.) and/or the like. The personal object 202 may further include one or more objects which may be allocated and/or intended for exclusive use by the respective user 204, for example, a credit card, a debit card, a smart card, a personal gift card and/or the like. The personal object 202 may further include one or more organic features of the respective user 204 which may be used for biometric verification of an identity of the respective user, for example, a face, an ear, an eye, an iris, a fingerprint, a skin and/or the like.

The counterfeit detection system 200 may include an Input/Output (I/O) interface 210, a processor(s) 212 for executing the process 100 and a storage 214 for storing code (program store) and/or data.

The I/O interface 210 may include one or more wired and/or wireless interconnection interfaces, for example, a Universal Serial Bus (USB) interface, a serial port, a Controller Area Network (CAN) bus interface, a Radio Frequency (RF) interface, a Bluetooth interface and/or the like. The I/O interface 210 may further include one or more interfaces for connecting to a network 208 comprising one or more wired and/or wireless networks, for example, a Local Area Network (LAN), a Wireless LAN (WLAN, e.g. Wi-Fi), a cellular network, the internet and/or the like.

Via the I/O interface 210, the counterfeit detection system 200 may communicate with one or more sensors 206, in particular, imaging sensors such as, for example, a camera, a video camera, a night vision camera, an Infrared camera, a thermal camera and/or the like deployed to capture one or more images of the personal object 202.

The counterfeit detection system 200 may further communicate, over the network 208, with one or more remote networked systems 230, for example, a server, a network node, a cluster of network nodes, a cloud service, a cloud platform and/or the like which may provide one or more services, for example, storage services, computing services and/or the like.

The processor(s) 212, homogenous or heterogeneous, may include one or more processing nodes arranged for parallel processing, as clusters and/or as one or more multi core processor(s). The storage 214 may include one or more non-transitory persistent storage devices, for example, a hard drive, a Flash array and/or the like. The storage 214 may also include one or more volatile devices, for example, a Random Access Memory (RAM) component and/or the like. The storage 214 may further comprise one or more network storage resources, for example, a storage server, a network accessible storage (NAS), a network drive and/or the like accessible via the I/O interface 210.

The processor(s) 212 may execute one or more software modules such as, for example, a process, a script, an application, an agent, a utility, a tool, an Operating System (OS) and/or the like each comprising a plurality of program instructions stored in a non-transitory medium (program store) such as the storage 214 and executed by one or more processors such as the processor(s) 212. The processor(s) 212 may optionally include, utilize and/or otherwise facilitate one or more hardware modules (elements) integrated, coupled and/or available to the counterfeit detection system 200, for example, a circuit, a component, an IC, an Application Specific Integrated Circuit (ASIC), a Field Programmable Gate Array (FPGA), a Digital Signals Processor (DSP), a Graphic Processing Units (GPU) and/or the like.

The processor(s) 212 may therefore execute one or more functional modules, for example, a counterfeit detector 220 for executing the process 100 which is utilized by one or more software modules, one or more of the hardware modules and/or a combination thereof.

The process 100 is described for a single personal object 202 associated with a single user 204, specifically a certain article of the personal object 202 associated with a respective user 204. However, this should not be construed as limiting since the process 100 may be expanded to a plurality of personal objects 202 associated with a plurality of respective users such as the user 204.

As shown at 102, the process 100 starts with the counterfeit detector 220 receiving sensory data, specifically imagery data comprising one or more images, for example, a still image, a sequence of images, a video clip and/or the like of the personal object 202 captured by one or more of the sensors 206 deployed to monitor and capture imagery data of the personal object 202.

For example, assuming the personal object 202 is a credit card, one or more sensors 206 may be deployed in one or more Automated Teller Machines (ATM) to capture imagery data of the credit card when used by the respective user 204 to operate the ATM. In another example, assuming the personal object 202 is an ID card and/or an ID paper, such as, for example, a passport, driver license, etc., used by the respective user 204 to authenticate himself to a human inspector and/or to an automated ID inspection system, one or more sensors 206 may be deployed to monitor an inspection area and/or inspection space in which the ID card/paper is presented and/or inspected. In another example, assuming the personal object 202 is an RFID tag used by the respective user 204 to access one or more restricted areas and/or operate one or more limited access systems. In such case one or more sensors 206 may be deployed to monitor an RFID reader located at the entrance to a restricted area and/or at an operation panel of a limited access system and capture imagery data of the RFID tag used by the respective user 204 to enter the restricted area or access the limited access system.

As shown at 104, the counterfeit detector 220 may analyze the image(s) to identify a wearing state of the personal object 202. Specifically, the counterfeit detector 220 may analyze the image(s) to identify one or more wearing marks exhibited (seen) by the personal object 202, in particular visual wearing marks, for example, de-coloration (fading, dullness, etc.), scratches, wrinkles (creases, furrows, etc.), tearing, physical deterioration and/or the like induced by one or more wearing conditions, for example, time, an environmental condition (e.g. exposure to light, humidity, etc.), a mechanical interaction with one or more other objects and/or forces, a chemical interaction with one or more contacting, radiating and/or emitting materials or substances and/or the like.

Moreover, the counterfeit detector 220 may further analyze each of the wearing mark(s) detected in the personal object 202 with respect to one or more operational parameters of manufacturing means and/or technologies available for producing the personal object 202, for example, resolution, capacity, ability and/or the like. Based on the analysis, the counterfeit detector 220 may select one or more identified wearing marks determined to be beyond the resolution, ability and/or capacity of existing production means and/or technologies such that the selected wearing mark(s) may be thus non-reproducible by artificial means.

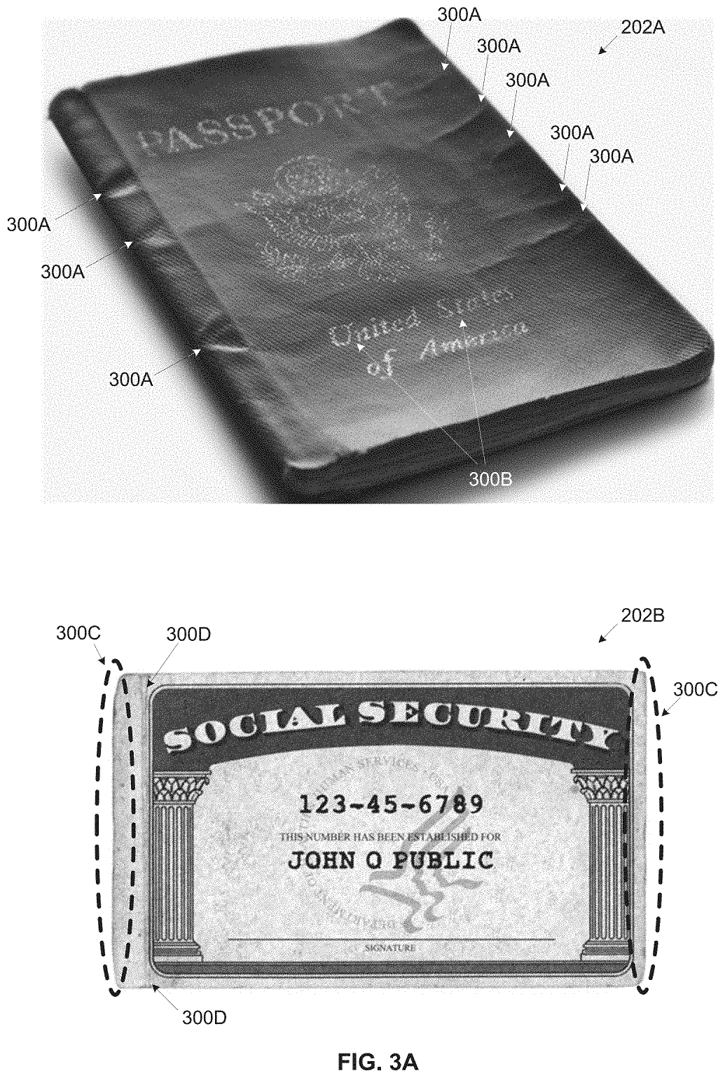

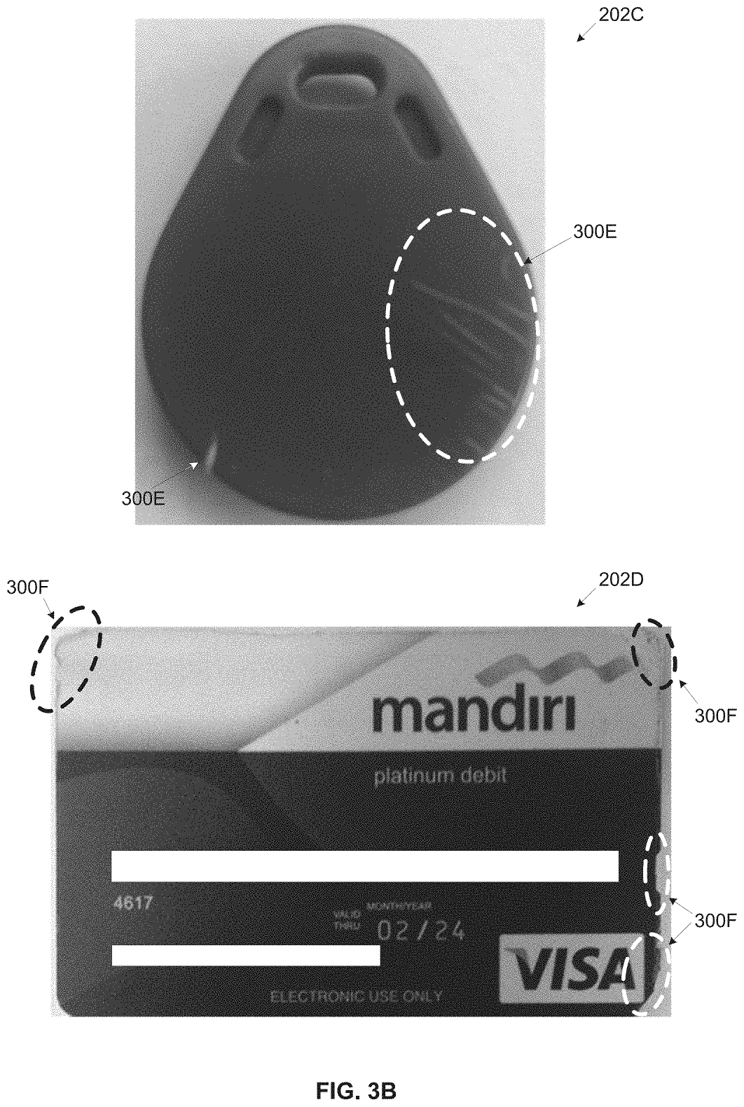

Reference is now made to FIG. 3A, and FIG. 3B present images of exemplary personal objects suffering wearing marks analyzed to detect counterfeit, according to some embodiments of the present invention.

As seen in FIG. 3A, an exemplary ID paper, specifically a passport 202A such as the personal object 202 may exhibit and/or suffer one or more wearing marks. For example, the passport 202A may have one or more wrinkles (creases, furrows, etc.) 300A, in particular along the cover edges of the passport 202A caused by one or more of the wearing conditions, for example, physical degradation over time, exposure to light and/or mechanical interaction induced by repeated use and store of the passport 202A. A counterfeit detector such as the counterfeit detector 220 analyzing one or more images of the passport 202A may identify the wrinkles 300A and may select one or more of the wrinkles 300A, optionally such wrinkles 300A which are determined to be artificially non-reproducible. In another example, one or more marks printed on the passport 202A may be faded due to one or more of the wearing conditions, for example, exposure to light and/or humidity. Based on the analysis of the image(s), the counterfeit detector 220 may identify the faded printed marks 300B and may select one or more of the faded printed marks 300B, optionally such faded printed marks 300B which are determined to be non-reproducible by artificial means.

Also seen in FIG. 3A, another exemplary ID paper, specifically a social security card 202B such as the personal object 202 may exhibit and/or suffer one or more wearing marks. For example, one or more of the edges 300C of the social security card 202B may be worn due to one or more of the wearing conditions, for example, mechanical interaction induced by repeated use and store of the social security card 202B. The counterfeit detector 220 analyzing one or more images of the social security card 202B may identify the worn edges 300C and may select one or more of the worn edges 300C, optionally such worn edges 300C which are determined to be artificially non-reproducible. In another example, the social security card 202B may include one or more folding marks 300D caused by one or more of the wearing conditions, for example, intended and/or unintended folding (mechanical interaction) of the social security card 202B when stored. Based on the analysis of the image(s), the counterfeit detector 220 may identify the folding marks 300D and may select one or more of the folding marks 300D, optionally such folding marks 300D which are determined to be non-reproducible by artificial means.

As seen in FIG. 3B, an RFID tag 202C such as the personal object 202 may exhibit and/or suffer one or more wearing marks, for example, one or more scratches 300E caused by one or more of the wearing conditions, for example, mechanical interaction induced by repeated mechanical contact with other objects during use and/or carry of RFID tag 202C. The counterfeit detector 220 analyzing one or more images of the RFID tag 202C may identify the scratches 300E and may select one or more of the scratches 300E, optionally such scratches 300E which are determined to be artificially non-reproducible.

Also seen in FIG. 3B, a credit card 202D such as the personal object 202 may exhibit and/or suffer one or more wearing marks, for example, a lamination layer covering the credit card 202D may be peeled at some locations 300F, in particular at one or more corners and edges of the credit card 202D. The lamination layer peelings 300F may be induced by one or more of the wearing conditions, for example, physical degradation over time, mechanical interaction induced by extraction and insertion of the credit card 202D from a wallet compartment and/or the like. The counterfeit detector 220 analyzing one or more images of the credit card 202D may identify the lamination layer pilings 300F and may select one or more of the lamination layer pilings 300F, optionally such lamination layer pilings 300F which are determined to be artificially non-reproducible.

Reference is made once again to FIG. 1.

As shown at 106, the counterfeit detector 220 a wearing pattern for the personal object 202, for example, a record (e.g. a file, an image, etc.) comprising (documenting, recording) the wearing mark(s) detected in the personal object 202.

The counterfeit detector 220 may further instruct storing the wearing pattern in one or more storage locations, for example, the storage 214, one or more of the remote networked resources 230 and/or the like. In particular, the wearing pattern may be stored in association with the personal object 202 in one or more data structures, for example, a database, an array and/or the like such that each wearing pattern may be unambiguous associated with its personal object 202 and may be easily and deterministically accessed and recovered.

As shown at 108, the counterfeit detector 220 may compare between the (current) wearing pattern and one or more previous wearing patterns to identify one or more differences between the wearing mark(s) recorded in the wearing pattern compared to the wearing mark(s) recorded in the previous wearing pattern(s). The previous wearing pattern(s) may be generated for the personal object 202 based on one or more analyses conducted to analyze past images of the personal object 202.

The counterfeit detector 220 may retrieve the previous wearing pattern(s) from one or more of the storage locations, for example, the storage 214, one or more of the networked resources 230 and/or the like in which the previous wearing pattern(s) is stored.

Based on the comparison between the wearing patterns, the counterfeit detector 220 may determine whether the wearing mark(s) recorded in one or more of the previous wearing patterns are present and detected in the currently generated wearing pattern.

As shown at 110, which is an optional step, the counterfeit detector 220 may compare between the current wearing pattern and a wearing mask reflecting an estimated wearing pattern of the personal object 202 to identify one or more differences between the wearing mark(s) recorded in the wearing pattern compared to the wearing mark(s) recorded in the wearing mask. The wearing mask may be computed and/or generated based on one or more of the previous wearing patterns, in particular a most recent previous wearing pattern.

The estimated wearing mask may include one or more estimated additional wearing marks which are not recorded in the previous wearing pattern(s) but are estimated by the counterfeit detector 220 to be acceptable as they may possibly, probably, legitimately and/or genuinely result from one or more of the wearing conditions induced during the time period since the previous wearing pattern(s) were generated, specifically the most recent wearing pattern.

For example, in case the time since the time of generation of the most recent previous wearing pattern is significantly long, the counterfeit detector 220 may estimate that it is possible that the personal object 202 may include one or more additional wearing marks which are not recorded in the most recent previous wearing pattern but may be legitimate waring marks which may have occurred during the time gap as result of one or more of the wearing conditions. For example, assuming the personal object 202 is the passport 202A printed with one or more printed marks. One or more of the printed marks may fade over time and therefore in case a significant time has elapsed since the time of generation of the most recent previous wearing pattern, the certain printed mark may have faded or further faded during that time. In another example, assuming the personal object 202 is the RFID tag 202C. The RFID tag 202C which may be in frequent use may suffer one or more wearing marks, for example, de-coloration, scratches and/or the like resulting from one or more of the wearing conditions, for example, mechanical interaction with other objects while the RFID tag 202C is used and/or carried.

The counterfeit detector 220 may therefore analyze one or more of the previous wearing patterns and compute the estimated wearing mask accordingly to include one or more additional wearing marks which are not recorded in the previous wearing patterns. For example, the tamper detector 240 may generate the wearing mask to include additional wearing mark(s) estimated as acceptable based on the time since the time of generation of the most recent previous wearing pattern.

The counterfeit detector 220 may further compute the estimated wearing pattern based on one or more wearing effects identified to affect the specific personal object 202 which are identified by analyzing a plurality of previous wearing patterns. Based on the analysis, the counterfeit detector 220 may identify a gradual wearing state typical for the specific personal object which may result from one or more of the wearing conditions which the specific personal object 202 is typically, frequently and/or occasionally exposed to.

For example, based on analysis of multiple previous wearing patterns, the counterfeit detector 220 may detect that a certain personal object 202, for example, a certain credit card 202D suffers gradual wearing in its lamination cover due to frequent use reflected in gradually expanding lamination layer peelings 300F. Based on the analysis, the counterfeit detector 220 may further identify a wearing rate and/or progress lamination layer peelings 300F. In such case, based on the time since the time of generation of the most recent previous wearing pattern, the counterfeit detector 220 may estimate an acceptable current wearing state of the lamination cover of the certain credit card 202D reflected by the estimated lamination layer peelings 300F and may compute the estimated wearing pattern accordingly for the certain credit card 202D. In another example, based on analysis of multiple previous wearing patterns, the counterfeit detector 220 may detect that that a certain personal object 202, for example, a certain RFID tag 202C suffers gradual wearing reflected by additional scratches 300E due to constant mechanical interaction resulting from the way the certain RFID tag 202C is typically is used and/or carried. Based on the analysis, the counterfeit detector 220 may further identify a wearing rate and/or progress of the scratches 300E. In such case, based on the time since the time of generation of the most recent previous wearing pattern, the counterfeit detector 220 may estimate an acceptable current wearing state of the certain RFID tag 202C reflected by the scratches 300E and may compute the estimated wearing mask accordingly for the certain RFID tag 202C.

Optionally, the counterfeit detector 220 computes and/or generates the wearing mask according to a time period since the time of issuance of the personal object 202. The estimated wearing mask computed by the counterfeit detector 220 based on the time since issuance may be applicable for a general type of the personal object 202, for example, a general type of the passport 202A, a general type of the social security card, a general type of the RFID tag, a general type of the credit card 202D, a general type of the smart card 202E and/or the like. However, the estimated wearing mask computed based on the time since issuance may be applicable for similar personal objects 202 which are used, carried stored and/or the like in standard, average and/or typical manner common to most users 204.

Optionally, the counterfeit detector 220 applies one or more Machine Learning Models (ML), for example, a neural network, an SVM and/or the like to use Artificial Intelligence (AI) for computing and/or generating the wearing mask for the personal object 202. The ML models may be trained and learned to correlate between various wearing conditions, for example, elapsed time, exposure to environmental conditions, mechanical interaction, mechanical interaction and/or the like and their effect on various personal objects 202, specifically the wearing effect induced by the wearing conditions on the personal objects 202. To this end, the ML model(s) may be trained in one or more supervised and/or unsupervised training sessions with one or more training datasets comprising images of personal objects 202 throughout their life cycle during which they are exposed to the wearing conditions thus reflecting a gradual wearing state of the personal objects 202. The ML modell(s) may thus learn, adjust and evolve to correlate between the wearing conditions and their impact on various personal objects 202.

The counterfeit detector 220 may therefore apply the trained ML model(s) to the image(s) of the personal object 202 to compare between the current wearing pattern and the wearing mask estimated by the ML model(s) which may be a general wearing mask applicable for similar personal object 202 used, carried stored and/or the like in the standard, average and/or typical manner common most users 204.

Moreover, the ML model(s) may be further applied to create a specific wearing mask for the specific personal object 202 which may reflect specific and possibly unique wearing mark(s) which are induced by the specific wearing condition(s) to which the specific personal object is exposed. To this end the trained ML model(s) may be further trained to create a specific wearing mask for the personal object 202 using at least some of the plurality of the previous wearing patterns generated for the specific personal object 202 based on analyses of past images of the specific personal object 202. For example, the trained ML model(s) may be further trained using a plurality of images reflecting the previous wearing patterns of the personal object 202.

The counterfeit detector 220 may therefore apply the trained ML model(s) adapted for the specific personal object 202 to the image(s) of the personal object 202 to compare between the current wearing pattern and the wearing mask estimated by the ML model(s) for the specific personal object 202.

As shown at 112, the counterfeit detector 220 may determine whether the personal object 202 is genuine or counterfeit based on the comparison between the wearing pattern of the personal object 202 and the previous wearing pattern(s) of the personal object 202 and optionally compared to the wearing mask estimated for the personal object 202.

For example, assuming a certain wearing mark which is recorded in one or more previous wearing patterns of the personal object 202 is not recorded in the current wearing pattern. In such case, the counterfeit detector 220 may determine that the personal object 202 may be a counterfeit since the wearing state of the personal object may typically degrade over time and wearing mark(s) such as the certain wearing mark may be added, expand and/or spread in the personal object 202 but are unlikely to disappear. The absence of the certain wearing mark may be therefore highly indicative that the personal object 202 is a counterfeit used in attempt to replicate the genuine personal object 202 recorded in the previous wearing patterns.

In another example, assuming counterfeit detector 220 determines that a certain wearing mark recorded in the wearing pattern may be artificially reproduced to replicate, imitate and/or resemble a genuine wearing mark which was present in the personal object 202 in the past and as such is recorded in one or more of the previous patterns. In such case, the counterfeit detector 220 may determine that the personal object 202 may be a counterfeit since the wearing mark(s) recorded in the wearing patterns are such wearing marks that are non-reproducible. The existence of such a reproducible wearing mark may be highly indicative that the personal object 202 is a counterfeit used in attempt to replicate the genuine personal object 202 recorded in the previous wearing patterns.

In another example, assuming counterfeit detector 220 determines that a certain wearing mark recorded in the wearing mask may significantly deviate from the wearing mask estimated for the personal object 202. In such case, the counterfeit detector 220 may determine that the personal object 202 may be a counterfeit since such a major deviation from the acceptable current wearing state may be highly indicative that the personal object 202 is not the same personal object 202 recorded in the previous wearing patterns.

In case the counterfeit detector 220 determines that the personal object 202 is a counterfeit object and/or article, the counterfeit detector 220 may initiate one or more actions to inform of the possibility that the personal object 202 may be a counterfeit.

For example, the counterfeit detector 220 may transmit one or more alert messages via the network 208 to one or more automated systems (e.g. security systems, etc.) and/or users (e.g. IT personnel, security personnel, etc.). In another example, the counterfeit detector 220 may instruct generation of one or more alert indications to be output to one or more users via one or more user interfaces available in the counterfeit detection system 200, for example, a display, a speaker, an alert Light Emitting Diode (LED) and/or the like. Complementary, in case the counterfeit detector 220 determines that the personal object 202 is genuine, the counterfeit detector 220 may initiate one or more actions to this effect, i.e. to inform that the personal object 202 is genuine, for example, transmit one or more approval messages via the network 208 to the automated system(s) and/or users, instruct generation of one or more approval indications to be output to one or more users via one or more user interfaces available in the counterfeit detection system 200, for example, a display, a speaker, an approval LED and/or the like.

According to some embodiments of the present invention, the same process 100 described for the personal object 202 may be applied to detect potential counterfeit object and/or article used in attempt to impersonate, replicate, imitate, and/or otherwise simulate one or more organic features of a respective user 204 which may be used to authenticate the identity of the respective user 204 using biometric verification. Such counterfeit objects and/or articles may include, for example, a picture, a model, a tape, a cast and/or the like which are configured, adjusted, adapted and/or produced to replicate one or more of the organic features of the user 204.

The counterfeit detector 220 may receive and analyze one or more images of the organic feature, for example, a face, an ear, an eye, an iris, a fingerprint, a skin, and/or the like in order to identify one or more wearing marks, for example, a wrinkle, a scar, a vitiligo, a freckle, a liver spot, a de-coloration area and/or the like induced in the organic feature by one or more wearing conditions, for example, age (time), environmental condition (e.g. exposure to light, cold, heat, humidity, etc.), fatigue, injury, illness, intentional alterations (e.g. tattoo, piercing, etc.), and/or the like.

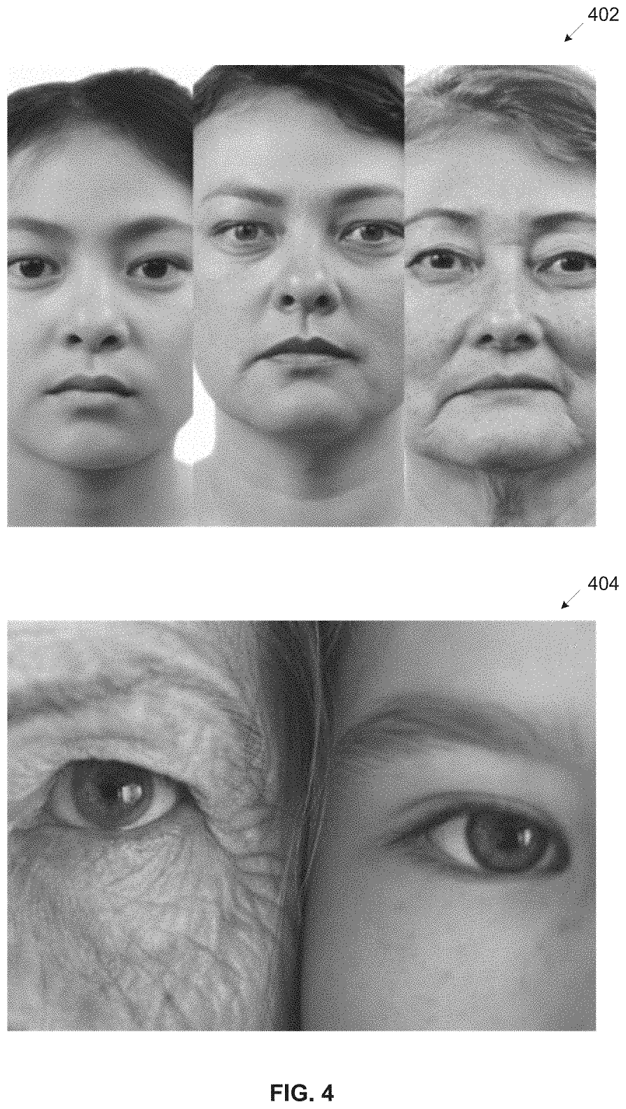

Reference is now made to FIG. 4, which presents images of exemplary organic features suffering wearing marks which may be analyzed to detect counterfeit, according to some embodiments of the present invention. Images 402 and 404 present gradual wearing over time of organic features of exemplary users 204, for example, face features, eye features, iris features and/or the like, specifically over the course of decades. As evident the gradual wearing state of the organic features may comprise addition, expansion, deepening and/or the like of one or more of the wearing marks, for example, wrinkles, freckles, de-coloration areas and/or the like.

The counterfeit detector 220 may generate a wearing pattern for the organic feature to include one or more of the identified wearing marks.

Optionally, the counterfeit detector 220 may analyze each of the wearing mark(s) detected in the organic feature with respect to means and/or technologies available for producing and/or creating the counterfeit objects and/or articles used to replicate, simulate, imitate and/or impersonate the organic feature. Based on the analysis, the counterfeit detector 220 may select one or more identified wearing marks determined to be beyond the resolution, ability and/or capacity of existing production means and/or technologies such that the selected wearing mark(s) may be non-reproducible by artificial means. As the wearing mark(s) may be non-reproducible, a corresponding counterfeit object and/or article comprising such wearing mark(s) may be extremely difficult and potentially impossible to produce.

The counterfeit detector 220 may then compare the wearing pattern of the organic feature with one or more previous wearing patterns generated for the organic feature based on analysis of one or more past images of the organic feature.

The counterfeit detector 220 may further compare the wearing pattern of the organic feature to an estimated wearing mask computed for the organic feature based on one or more of the previous wearing patterns. The counterfeit detector 220 may optionally apply one or more of the trained ML models to generate and compare an estimated wearing mask, either a general wearing mask created for an averaged organic feature and/or a customized wearing mask created for the organic feature of the specific user 204.

The counterfeit detector 220 may then determine, based on the comparison, whether the organic feature is the genuine organic feature of the user 204 or it is a counterfeit object used in attempt to impersonate, replicate, imitate, and/or otherwise simulate the genuine organic feature of the user 204.

For example, assuming the organic feature used to authenticate the user 204 is his face, a two-dimensional picture depicting the face of the user 204 in real scale and proportions may be used in attempt to impersonate the face of the user 204. Further assuming that the picture was taken in the past and is thus missing one or more wearing mark(s), for example, a wrinkle and/or the like which are recorded in one or more of the previous wearing patterns. In such case, the counterfeit detector 220 may determine, based on the comparison, that the organic feature (which is in fact simulated by the picture) is a counterfeit since it is improbable that the wearing marks, e.g. the wrinkle(s) disappear over time.

In another example, assuming the organic feature used to authenticate the user 204 is his fingerprint, a tape or a cast of the fingerprint may be used in attempt to impersonate the finger(s) of the user 204. Further assuming that the tap/cast was made in the past and is thus missing one or more wearing mark(s), for example, a small scar and/or the like which is recorded in one or more of the previous wearing patterns. In such case, the counterfeit detector 220 may determine, based on the comparison, that the organic feature (which is in fact simulated by the tape/cast) is a counterfeit since it is improbable that wearing mark(s), i.e., the scar will disappear over time.

According to some embodiments of the present invention, personal objects may be identified to be genuine or counterfeit based on identifying and tracking manufacturing defects detectable in the personal object 202. As such, the personal object 202 may be validated, verified and/or authenticated to be genuine or counterfeit according to unique manufacturing defects deviating from manufacturing instructions used to produce the personal product 202 thus distinguishing each personal product article from other articles of the personal object produced according to the same manufacturing instructions.

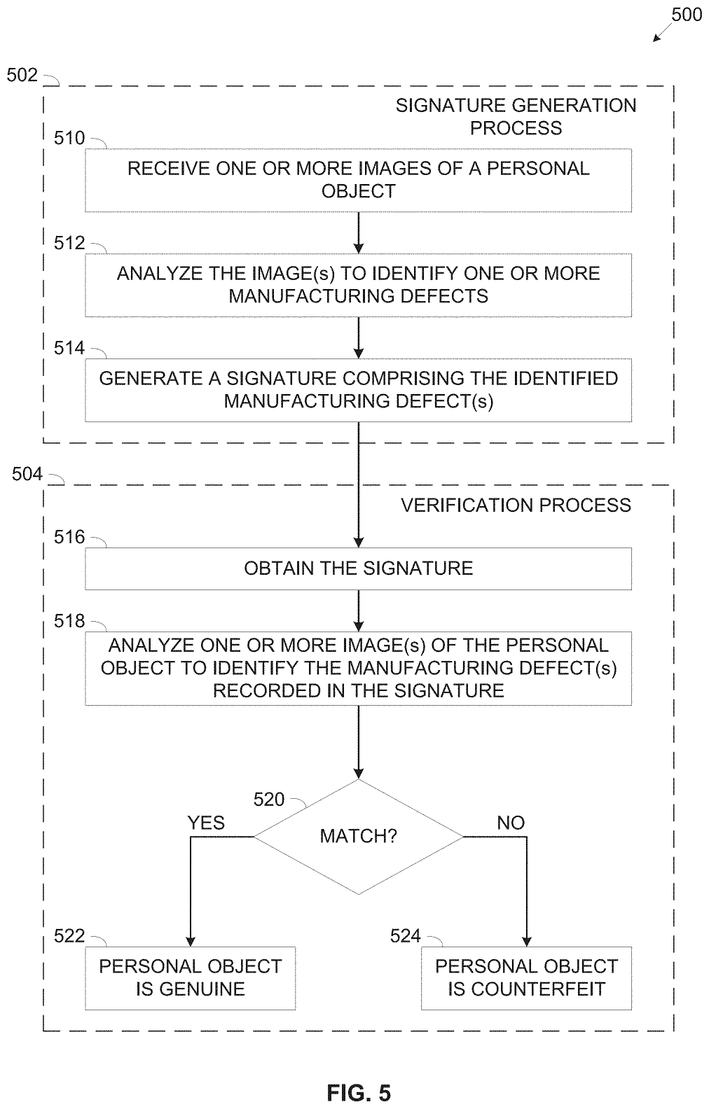

Reference is now made to FIG. 5, which is a flowchart of an exemplary process of detecting counterfeit of a personal object based on manufacturing defects identified in the personal object, according to some embodiments of the present invention.

An exemplary process 500 may be executed to determine whether an object such as the object 202 is genuine or counterfeit by analyzing and tracking one or more manufacturing defects initially identified at the end of a manufacturing process of the personal object which may comprise one or more deviations from manufacturing instructions used to produce the personal object 202.

The process 500 is described for a single personal object 202 associated with a single user 204, specifically a certain article of the personal object 202 associated with a respective user 204. However, this should not be construed as limiting since the process 500 may be expanded to a plurality of personal objects 202 associated with a plurality of respective users such as the user 204.

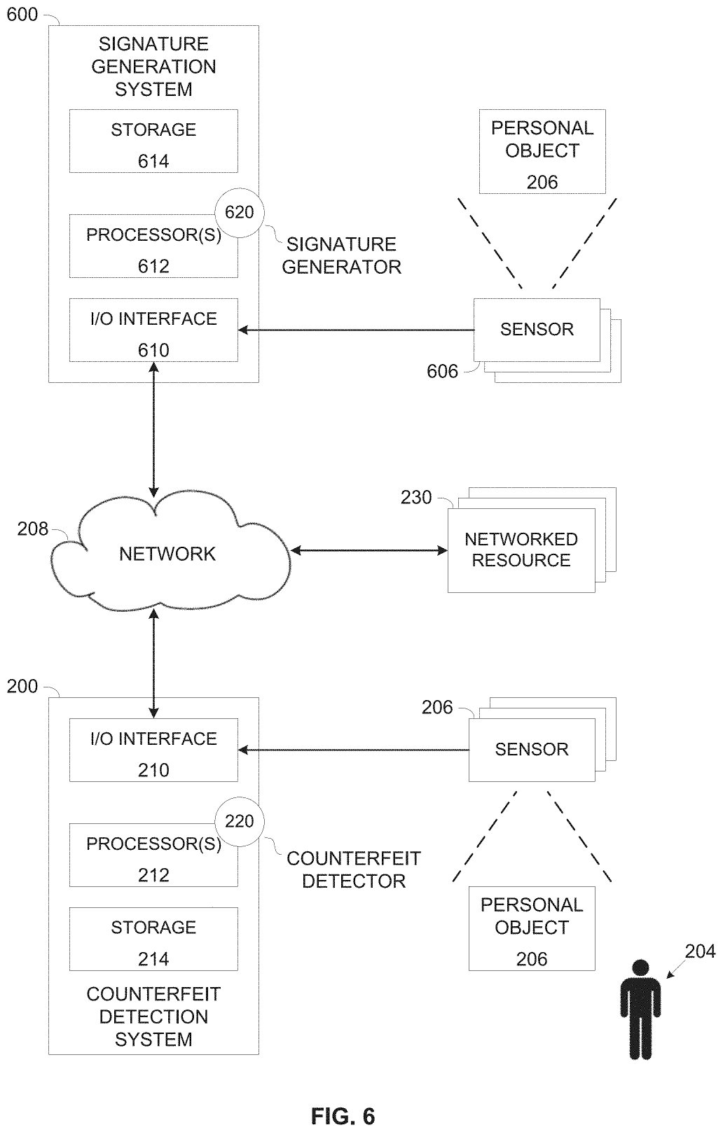

Reference is also made to FIG. 6, which is a schematic illustration of an exemplary system for detecting counterfeit of a personal object based on manufacturing defects identified in the personal object, according to some embodiments of the present invention.

A signature generation system 600 such as the counterfeit detection system 200 may include an I/O interface 610 such as the I/O interface 210, a processor(s) 612 such as the processor(s) 212 and a storage 614 such as the storage 214 for storing code (program store) and/or data.

Via the I/O interface 610, the signature generation system 600 may communicate with one or more sensors 606 such as the sensor 206, in particular, imaging sensors deployed to capture one or more images of the personal object 202, specifically to capture image(s) of the personal object 202 at the end of the manufacturing process conducted to produce the personal object 202. Via the I/O interface 610, the signature generation system 600 may further communicate, over a network such as the network 208, with one or more remote networked systems such as the network resource 230 which may provide one or more services, for example, storage services, computing services and/or the like.

The processor(s) 612 may therefore execute one or more functional modules, for example, a signature generator 620 which may be utilized by one or more software modules, one or more of the hardware modules and/or a combination thereof for executing the signature generation process 502.

The process 500 is composed of two main processes, a signature generation process 502 and a verification process 104.

The signature generation process 102 may be conducted by the signature generator 620 executed by the signature generation system 600 at the end of a manufacturing process of the personal object 202, specifically at the end of production of a specific article of the personal object 202 associated with a respective use such as the user 204.

As shown at 510, the process 502 starts with the signature generator 620 receiving sensory data, specifically imagery data comprising one or more images, for example, a still image, a sequence of images, a video clip and/or the like of the personal object 202 captured by one or more of the sensors 606 deployed to monitor and capture imagery data of the personal object 202, specifically at the end of the production process of the personal object 202.

For example, one or more sensors 606 may be deployed at the production line of the personal object 202 and may capture one or more images of the personal object when coming out of the production line. In another example, one or more sensors 606 may be deployed at a quality assurance station where the personal object 202 is examined after production to approve the personal object use.

As shown at 512, the signature generator 620 may analyze the image(s) to identify one or more manufacturing defects in the personal object 202 which are each characterized by one or more deviations from a set of manufacturing instructions used to produce the personal object 202. Each of the manufacturing defect(s) may be defined and/or encompassed by one or more of the features defining the personal object 202, specifically visual features defining the visual appearance of the personal object 202, for example, printed and/or carved features (e.g. text, symbols, marks, etc.), mechanical features (e.g. contour, protrusions, cavities, etc.) and/or the like.

Each such deviation may result from one or more inconsistencies, deviations and/or inherent random characteristics of the production means used to produce the personal object 202, for example, equipment, machinery, materials, substances and/or the like. For example, assuming the personal object 202 is an ID card comprising marks (printed features) printed and/or marked by one or more printing devices, for example, a printer, a spraying machine, a pressing machine and/or the like using one or more printing materials, for example, ink, paint, pressing element and/or the like. While the ID card may be produced according to strict manufacturing instructions, one or more of the marks may deviate from a reference mark defined by the manufacturing instructions due to one or more imprecisions and/or parameters of the printing device(s). For example, due to some imprecision in a printing mechanism of a certain printing device, one or more of the printed marks may slightly deviate from a respective reference mark, for example, have a missing portion, have an extra print element, have a different coloration in one or more sections of the mark, have a different width for one or more print elements and/or the like. In another example, assuming the personal object 202 is an RFID tag comprising one or more mechanical features created using one or more mechanical machinery, for example, a Computer Numerical Control (CNC) machine, a molding machine and/or the like and optionally comprising one or more marks printed and/or marked by one or more printing devices using one or more printing materials. While the RFID tag may be produced according to strict manufacturing instructions, one or more of the mechanical features, for example, a protrusion, a cavity, a hole, a contour line and/or the like may deviate from a reference mechanical feature defined by the manufacturing instructions due to one or more imprecisions and/or parameters of the mechanical machinery. For example, due to some imprecision in a cutting element of a certain mechanical machine, one or more of the mechanical features may slightly deviate from a respective reference feature, for example, have a protrusion, a gap, a void, a dent and/or the like.

Moreover, one or more of the manufacturing defects detected in the personal object 202 may comprise one or more deviations which are beyond the resolution, ability and/or capacity of the production means used to produce the personal object 202 and are therefore non-reproducible. For example, the signature generator 620 may detect a certain deviation in a certain mark printed on a certain personal object 202, for example, a certain ID card which results from an imprecision in the printing device used to print the certain mark since such deviation may typically be beyond a printing resolution of the printing device and therefore the certain deviation may not be artificially reproduced. In another example, the signature generator 620 may detect a certain deviation in a certain mark printed on a certain personal object 202, for example, a certain ID paper which results from the random dissemination of the ink which may not be artificially reproduced. In another example, the signature generator 620 may detect a certain deviation in a certain mechanical feature, for example, a protrusion in a contour of a certain personal object 202, for example, an RFID tag which results from an imprecision in a mold and/or a CNC machine used to produce the RFID tag and may be therefore non-reproducible.

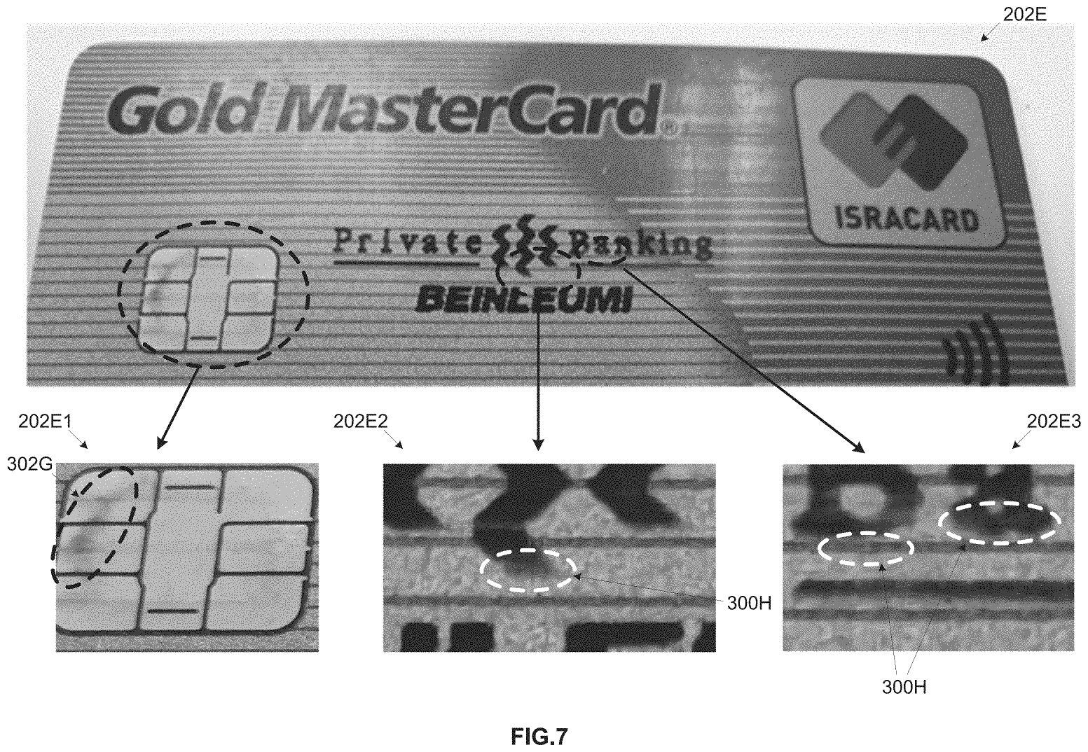

Reference is now made to FIG. 7, which is an image of an exemplary personal object suffering manufacturing defects which may be analyzed to detect a counterfeit object, according to some embodiments of the present invention.

A smart card 202E such as the personal object 202 may exhibit and/or suffer one or more production defects comprising one or more deviations from the manufacturing instructions used to produce the smart card 202E. For example, as seen in section 202E1 of the smart card 202E, an Integrated Circuit (IC) may be unintentionally grazed during the manufacturing process, for example due to unplanned mechanical interaction with a production machine and may thus suffer one or more scarping marks 302G. Such scarping marks 302G may optionally be non-reproducible by artificial means. The signature generator 620 analyzing one or more images of the smart card 202E may identify the scarping marks 302G. In another example, the smart card 202E may comprise one or more printed marks 300H which are printed with ink and are optionally elevated sections and/or protrusions in the surface of the smart card 202E. As seen in sections 202E2 and 202E3 of the smart card 202, the outline of one or more of the printed marks 300H may be slightly distorted due to imperfections in the printing device used to print the marks and/or due to unintended (unplanned) dissemination of the ink. Based on the analysis of the image(s), the signature generator 620 may identify the distorted printed marks 300H. Optionally, the signature generator 620 analyzing the distorted printed marks 300H with respect to available production means may determine that the distorted elevated marks 300H are non-reproducible by artificial means.

Reference is made once again to FIG. 6.

As shown at 514, the signature generator 620 may generate a signature for the personal object 202, specifically for the specific article of the personal object 202. The signature comprising (recording) the manufacturing defect(s) detected in the personal object 202 may be generated in one or more forms, for example, a record (e.g. a file, an image, etc.) and/or the like.

The signature generator 230 may instruct storing the signature in one or more storage locations, for example, the storage 616, one or more of the remote networked resources 230 and/or the like. In particular, the signature may be stored in association with the personal object 202 in one or more data structures, for example, a database, an array and/or the like such that each signature may be unambiguous associated with the respective personal object 202 (article) and may be easily and definitively accessed and recovered.

The verification process 104 may be conducted at one or more later times, for example, when the personal object 202 (e.g., ID card, ID paper, RFID tag, etc.) is used to identify the respective user 204 and/or when the user 204 is authorized (approved) to use his respective personal object 202, i.e. the specific article of the personal object 202 (e.g., credit card, debit card, smart card, personal gift card, etc.). The verification process 104 may be conducted by a counterfeit detection system such as the counterfeit detection system 200 executing a counterfeit detector such as the counterfeit detector 220 which may be utilized by one or more software modules, one or more of the hardware modules and/or a combination thereof.

As shown at 516, the process 504 starts with the counterfeit detector 220 obtaining the signature created by the signature generator 620 for the personal object 202 from one or more of the storage locations, for example, the storage 616, one or more of the networked resources 230 and/or the like in which the signature is stored. For example, the counterfeit detector 220 may communicate via the network 208 with the signature generation system 600 and/or with one or more of the networked resources 230 to obtain the signature of the personal object 202.

As shown at 518, the tamper detector 240 may analyze sensory data captured by one or more sensors such as the sensor 206 deployed to depict the personal object 202, specifically visual sensory data comprising one or more images of the personal object 202. Specifically, the counterfeit detector 220 analyzes the image(s) of the personal object 202 to identify the manufacturing defect(s) recorded in the signature of the personal object 202.

The sensor(s) 206 may be deployed as described in step 104 of the process 100 to capture imagery data of the personal object 202 when used by the respective user 204.

As shown at 520, which is a conditional step, in case the counterfeit detector 220 identifies in the image(s) of the personal object 202 all the manufacturing defect(s) recorded in the signature are present in the images of the personal object 202, the counterfeit detector 220 may determine that the personal object 202 matches its signature and the process 504 branches to 522. However, in case the counterfeit detector 220 determines that one or more of the manufacturing defect(s) recorded in the signature are absent (not present) in the images of the personal object 202, the counterfeit detector 220 may determine that the personal object 202 does not match its signature and the process 504 branches to 524. This means that the process 500 may branch to 522 only if the counterfeit detector 220 determines that all the manufacturing defects recorded in the signature are present in the analyzed image(s) of the personal object 202 and no unrecorded manufacturing defects which are not recoded in the signature are present in the analyzed image(s). For example, in case a first manufacturing defect which is recorded in the signature is not identified in the analysis of the image(s) of the personal object 202, the counterfeit detector 220 may determine that the first manufacturing is absent in the image(s). Moreover, in case the counterfeit detector 220 determines that a second manufacturing defect identified in the analyzed images(s) which is not recorded in the signature, the counterfeit detector 220 may also determine that the second manufacturing defect is absent.

As shown at 522, since the counterfeit detector 220 identified that all the manufacturing defect(s) recorded in the signature are present in the personal object 202 and also no unrecorded manufacturing defect(s) are present in the personal object 202, the counterfeit detector 220 may determine that the personal object 202 is genuine.

As shown at 524, since the counterfeit detector 220 identified that one or more of the manufacturing defect(s) recorded in the signature are absent from the personal object 202, the counterfeit detector 220 may determine that the personal object 202 is a counterfeit object and/or article.

In case the counterfeit detector 220 determines that the personal object 202 is a counterfeit object and/or article, the counterfeit detector 220 may initiate one or more of the actions to inform of the possibility that the personal object 202 may be a counterfeit. Complementary, in case the counterfeit detector 220 determines that the personal object 202 is genuine, the counterfeit detector 220 may initiate one or more of the actions to this effect, i.e. to inform that the personal object 202 is genuine.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms personal objects and ID verification objects are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of detecting counterfeit of a personal object, comprising:
analyzing at least one image depicting a personal object to identify at least one wearing mark in the personal object induced by at least one wearing condition;
generating a wearing pattern comprising the at least one wearing mark;
comparing between the wearing pattern and at least one previous wearing pattern created for the personal object based on past images of the personal object; and
determining whether the personal object is genuine or counterfeit based on the comparison.

2. The method of claim 1, wherein the personal object is associated with a respective user and is used for verification of an identity of the respective user.

3. The method of claim 1, wherein the personal object is associated with a respective user and is intended for exclusive use by the associated user.

4. The method of claim 1, wherein the personal object is a member of a group consisting of: an identification (ID) card, a credit card, an ID tag, an RFID tag and, an ID paper.

5. The method of claim 1, wherein the personal object further comprising at least one organic feature of a respective user which is used for biometric verification of an identity of the respective user, the at least one organic feature is a member of a group consisting of: a face, an iris, a fingerprint, and a skin.

6. The method of claim 1, wherein the at least one wearing condition comprising: time, an environmental condition, a mechanical interaction and a chemical interaction.

7. The method of claim 1, further comprising at least one wearing mark is beyond a production ability of production means used to produce the personal object and is hence non-reproducible.

8. The method of claim 1, further comprising determining whether the personal object is genuine or counterfeit based on a comparison between the wearing pattern and a wearing mask estimated for the personal object based on analysis of the at least one previous wearing pattern.

9. The method of claim 8, wherein the wearing mask is estimated according to at least one wearing effect reflected by a gradual wearing state identified based on comparison between a plurality of previous wearing patterns.

10. The method of claim 8, further comprising estimating the wearing mask based on a time period since issuance of the personal object.

11. The method of claim 8, wherein the wearing mask is estimated based on an outcome of at least one trained Machine Learning (ML) model applied to the at least one image, the at least one trained ML model is trained with a plurality of training wearing patterns derived from a plurality of training images of a plurality of personal objects such as the personal object.

12. The method of claim 11, wherein at least some of the plurality of training wearing patterns reflect a gradual wearing state of at least some of the plurality of personal objects as identified in respective images of the plurality of images.

13. A system for detecting counterfeit of a personal object, comprising:
using at least one processor executing a code, the code comprising:
code instruction to analyze at least one image depicting a personal object to identify at least one wearing mark in the personal object induced by at least one wearing condition;
code instruction to generate a wearing pattern comprising the at least one wearing mark;
code instruction to compare between the wearing pattern and at least one previous wearing pattern created for the personal object based on past images of the personal object; and
code instruction to determine whether the personal object is genuine or counterfeit based on the comparison.

14. A method of detecting counterfeit of a personal object, comprising:
in a signature generation process:
analyzing at least one image of a personal object to identify at least one manufacturing defect comprising at least one deviation from object generation instructions used in a manufacturing process to produce the personal object,
generating a signature recording the at least one manufacturing defect, and in a verification process:
obtaining the signature,
analyzing at least one image of the personal object to identify the at least one manufacturing defect recorded in the signature,
determining whether the personal object is genuine or counterfeit based on presence or absence of the at least one manufacturing defect.

15. The method of claim 14, further comprising at least one deviation is beyond a production ability of production means used to produce the personal object and is hence non-reproducible.

16. A system for detecting counterfeit of a personal object, comprising:
in a sealing process:
using at least one processor executing a code, the code comprising:
code instruction to analyze at least one image of a personal object to identify at least one manufacturing defect comprising at least one deviation from object generation instructions used in a manufacturing process to produce the personal object,
code instruction to generate a signature recording the at least one manufacturing defect, and
in a verification process:
using at least one processor executing a code, the code comprising:
code instruction to obtain the signature,
code instruction to analyze at least one image of the personal object to identify the at least one manufacturing defect recorded in the signature,
code instruction to determine whether the personal object is genuine or counterfeit based on presence or absence of the at least one manufacturing defect.
